(19) United States
(12) Patent Application Publication
(10) Pub. No.: US 2019/0235899 A1
(43) Pub. Date: Aug. 1, 2019

(54) TRACKING VIRTUAL MACHINE DATA

(71) Applicant: Nutanix, Inc., San Jose, CA (US)

(72) Inventor: Ravikanth Samprathi, San Jose, CA (US)

(21) Appl. No.: 15/883,779

(22) Filed: Jan. 30, 2018

(51) Int. Cl. G06F 9/455; G06F 17/30

(52) U.S. Cl. CPC G06F 9/45558; G06F 17/30283; G06F 2009/45591; G06F 2201/84; G06F 2009/45583; G06F 2009/45587

(57) ABSTRACT

Disclosed herein are related to a method, a system, and a non-transitory computer readable medium for tracking data objects associated with a virtual machine. In one approach, an object container of the virtual machine is generated. The object container includes data objects associated with the virtual machine. For each of the data objects, a corresponding tag is generated. Each tag is indicative of a corresponding data object. Each tag includes a global identification of the corresponding data object. The global identification is unique across a distributed database. The tags are stored at the distributed database.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system.

In some implementations, virtual computing systems may be implemented on various cloud systems. For example, virtual machine images, metadata associated with virtual machines, or volume data associated with virtual machine may be stored by various cloud systems. Different cloud systems may operate or store data according to different formats. However, managing and tracking resources associated virtual computing systems stored by different cloud systems may be difficult and inefficient.

### BRIEF DESCRIPTION OF THE DRAWINGS

FIG. 1 is a block diagram of a virtual computing system, in accordance with some embodiments of the present disclosure.

FIG. 2 is a block diagram of an example virtual machine tracker, in accordance with some embodiments of the present disclosure.

FIGS. 3A and 3B illustrate example formats of data associated with virtual machines, in accordance with some embodiments of the present disclosure.

FIG. 4 is an example flowchart showing a process for generating data associated with virtual machine for tracking, in accordance with some embodiments of the present disclosure.

FIG. 5 illustrates a block diagram of a computing system suitable for implementing particular embodiments disclosed herein.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Various embodiments disclosed herein are related to a method, a system, and a non-transitory computer readable medium for tracking data objects associated with a virtual machine. Data objects associated with a virtual machine may be a virtual machine object, a volume object, a virtual network object, and a snapshot object associated with the virtual machine. In one approach, an object container of the virtual machine is generated. The object container is a virtual container including data objects associated with the virtual machine. For each of the data objects, a corresponding tag may be generated. A tag is an indicator indicating a corresponding data object. Each tag includes a global identification of the corresponding data object. The global identification is unique across a distributed database. The tags are stored at the distributed database.

In one aspect, the distributed database may include a first distributed database and a second distributed databased operated by different entities. Tracking data stored across distributed database operated by different entities may be difficult, for example, due to inconsistent format or different conventions. In some embodiments, each of the tags is stored as a key, and an associated metadata associated with said each of the tags is stored as a value. Preferably, each of the tags is stored as two layers of key-value pairs. The two layers of key-value pairs may include a first layer of a key-value pair and a second layer of a key-value pair. The first layer of the key-value pair may include (i) a tag of a data object as a key and (ii) an associated metadata indicating a location of the second layer of the key-value pair stored as a value. The second layer of the key-value pair may include (i) a characteristic of the data object as a key and (ii) a description of the distributed database storing the data object together with the global identification of the global identifier as a value. Accordingly, a data object can be easily tracked based on its corresponding tag, even though a plurality of data objects associated with the virtual machine may be stored across a distributed database. Moreover, a group of data objects sharing a common characteristic can be easily identified based on tags of the plurality of data objects, and configurations of the identified data objects can be seamlessly changed. For example, security configurations or other policy configurations of virtual machines sharing the common characteristic can be identified and configured together.

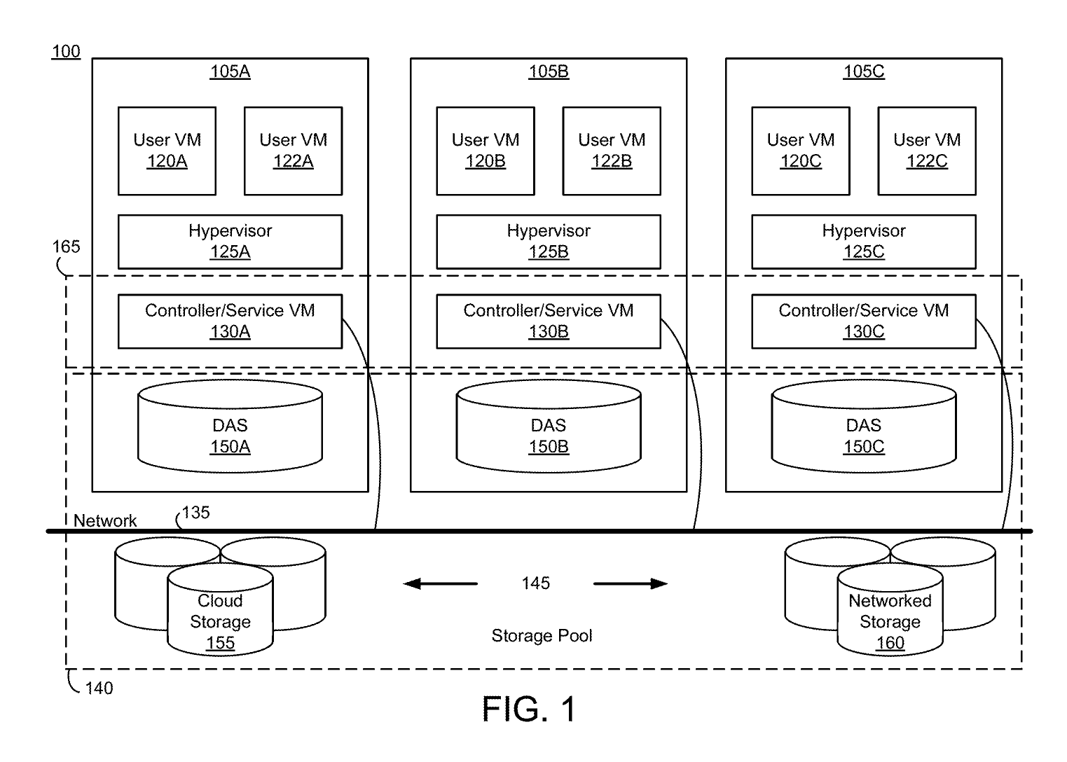

Referring now to FIG. 1, a virtual computing system 100 is shown, in accordance with some embodiments of the present disclosure. The virtual computing system 100 includes a plurality of nodes 105A, 105B, 105C. Each of the nodes 105A, 105B, 105C includes user virtual machines (VMs) 120, 122, and a hypervisor 125 configured to create and run the user VMs. Each of the nodes 105 also includes a controller/service VM 130 that is configured to manage, route, and otherwise handle workflow requests to and from the user VMs 120 of a particular node. The controller/service VM 130 is connected to a network 135 to facilitate communication between the nodes 105. Although not shown, in some embodiments, the hypervisor 125 may also be connected to the network 135. In other embodiments, each node 105 includes more, fewer or different components than shown in FIG. 1. For example, the node 105 includes a single VM, or any number of VMs.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the nodes 105, such that each of the nodes 105 may access its respective direct-attached storage 150 without having to access the network 135.

It is to be understood that certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, which is incorporated by reference herein in its entirety.

Although three of the plurality of nodes 105A, 105B, 105C are shown in the virtual computing system 100, in other embodiments, greater than or fewer than three nodes may be employed. Likewise, although two of the user VMs 120, 122 are shown on each of the nodes 105, in other embodiments, the number of the user VMs on any of the nodes 105 may vary to include either a single user VM or more than two user VMs. Further, the nodes 105 may have different number of the user VMs 120, 122. Additionally, more than a single instance of the hypervisor 125 and/or the controller/service VM 130 may be provided on one or more of the nodes 105A, 105B, 105C.

In some embodiments, each of the nodes 105A, 105B, 105C may be a hardware device, such as a server. For example, in some embodiments, one or more of the nodes 105A, 105B, 105C may be an NX-1000 server, NX-3000 server, NX-6000 server, NX-8000 server, etc., provided by Nutanix, Inc. or server computers from Dell, Inc., Lenovo Group Ltd. or Lenovo PC International, Cisco Systems, Inc., etc. In other embodiments, one or more of the nodes 105A, 105B, 105C may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the nodes 105A, 105B, 105C may also be configured to communicate and share resources with each other via the network 135. For example, in some embodiments, the nodes 105A, 105B, 105C may communicate and share resources with each other via the controller/service VM 130 and/or the hypervisor 125. One or more of the nodes 105A, 105B, 105C may also be organized in a variety of network topologies, and may be termed as a “host” or “host machine.”

Also, although not shown, one or more of the nodes 105A, 105B, 105C may include one or more processing units configured to execute instructions. The instructions may be carried out by a special purpose computer, logic circuits, or hardware circuits of the nodes 105A, 105B, 105C. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective nodes 105 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the nodes 105 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the nodes 105) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the nodes 105) to run multiple instances of the user VMs 120, with each user VM sharing the resources of that one physical server computer, potentially across multiple environments. By running the plurality of user VMs 120 on each of the nodes 105, multiple workloads and multiple operating systems may be run on a single piece of underlying hardware computer (e.g., the nodes 105) to increase resource utilization and manage workflow.

The user VMs 120 are controlled and managed by the controller/service VM 130. The controller/service VM 130 of each of the nodes 105 is configured to communicate with each other via the network 135 to form a distributed system 165. The hypervisor 125 of each of the nodes 105 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the nodes 105. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

In some embodiments, one of the nodes 105 may be configured as a leader node. The leader node may be configured to monitor and handle requests from other nodes in the virtual computing system 100. If the leader node fails, another leader node may be designated. Furthermore, one or more of the nodes 105 may be combined together to form a network cluster (also referred to herein as simply “cluster”). Generally speaking, all of the nodes 105 in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other. In some embodiments, multiple clusters may share resources with one another.

In one or more embodiments, the virtual computing system 100 may operate as a consolidated cloud system to access the resources (e.g., storage, processing unit, etc.) of different cloud systems (or different cloud storage). The cloud storage 155 or one or more of the nodes 105 may be operated by different cloud service providers. For example, a cloud storage 155 may be AWS S3 data storage from AMAZON, OnMetal data storage from Rackspace, Azure database from StorSimple, Google cloud storage from Google, Xi cloud storage from NuTanix, etc. Different cloud systems may be optimized for different characteristics. For example, one cloud system may be more efficient for SQL database, where another cloud system may be more efficient in terms of cost per storage, and another cloud system may be more efficient in terms of operation speed.

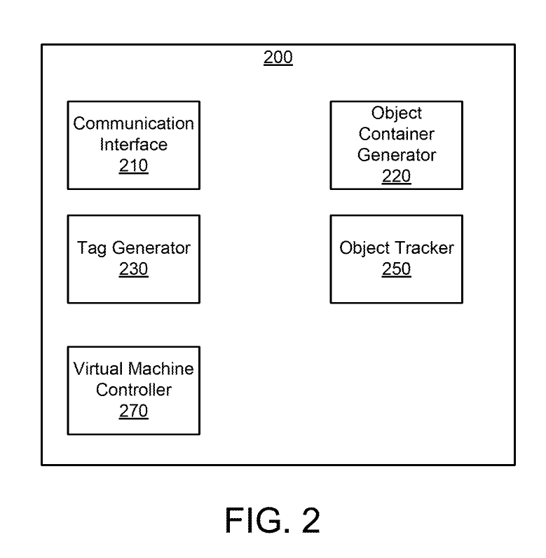

In one aspect, the virtual computing system 100 implements an object container including data objects associated with a virtual machine, where each data object is identified by a corresponding tag including a global identifier. Examples of data objects include a virtual machine object, a volume object, a virtual network object, a snapshot object, etc. According to the object container including data objects, and tags associated with corresponding data objects, the virtual computing system 100 can track data objects or virtual machines with a particular characteristic. For example, the virtual computing system 100 may identify virtual machines operated by a particular entity and change security configurations of the identified virtual machines. For another example, the virtual computing system 100 may identify virtual machines operating in a particular version, and update the virtual machine operating on outdated versions. Detailed examples and process of generating object containers and tags are described below with respect to FIGS. 2 through 4.

Referring to FIG. 2, illustrated is a block diagram of an example virtual machine tracker 200, in accordance with some embodiments of the present disclosure. In some embodiments, the virtual machine tracker 200 includes a communication interface 210, an object container generator 220, tag generator 230, an object tracker 250, and a virtual machine controller 270. These components operate together to generate object containers and tags for tracking data associated with virtual machines. The virtual machine tracker 200 may be embodied as one of the components (e.g., user VM, 120, hypervisor 125, controller service VM 130, or a combination of them) of a node 105. In some embodiments, the virtual machine tracker 200 includes more, fewer, or different components than shown in FIG. 2. For example, the virtual machine controller 270 may be omitted or implemented separately from the virtual machine tracker 200 in some embodiments.

The communication interface 210 is a component that interfaces the network 135. The communication interface 210 may receive instructions or commands from a user device. The user device may be a computing device (e.g., a node 105) operated by a user. The instructions or commands may be a request to store data associated with a virtual machine, track status of the virtual machine, identify virtual machines with particular characteristics, change configurations of the virtual machines, etc. The communication interface 210 may forward the received instructions or commands to one or more components of the virtual machine tracker 200. The communication interface 210 may also receive data associated with a virtual machine or operating status of the virtual machine from one or more components of the virtual machine tracker 200, and forward the received data associated with the virtual machine or operating status of the virtual machine to the user device.

The object container generator 220 is a component that receives a user instruction to store data associated with a virtual machine, and generates an object container including one or more data objects associated with the virtual machine. Data objects are data constituting the virtual machine. Examples of data objects include a virtual machine object, a volume object, a virtual network object, and a snapshot object. Virtual object may be data for virtual machine image. Volume object may be data indicative of storage allocated of the virtual machine. Virtual network object may be data indicative of virtual network employed by the virtual machine. Snapshot object may be data indicative of previously stored status of the virtual machine. The object container generator 220 may generate different data objects in response to a request to generate a virtual machine. The object container generator 220 may store different data objects at a consolidated database including different databases operated by different entities according to characteristics of the data objects. For example, the object container generator 220 may store virtual machine objects of different virtual machines at a first distributed database and store snapshot objects of different virtual machines at a second distributed database.

The tag generator 230 is a component that generates a tag for a corresponding data object. A tag is a data identifying a corresponding data object. In one aspect, each tag includes a global identification of the corresponding data object. The global identification (also referred to as “UUID”) is unique across a consolidated database including different databases operated by different entities. Hence, each tag allows data objects to be identified, even though different data objects are stored by different databases. In one aspect, the tag generator 230 generates a key-value pair to store (i) the tag indicating an associated data object as a key and (ii) associated metadata indicating characteristics of the data object as a value, and stores the key-value pair at the distributed database (e.g., network-attached storage 145, direct-attached storage 150, cloud storage 155, local storage area network 160, or any combination of them). The tag generator 230 may store key-value pairs of different data objects at the distributed database.

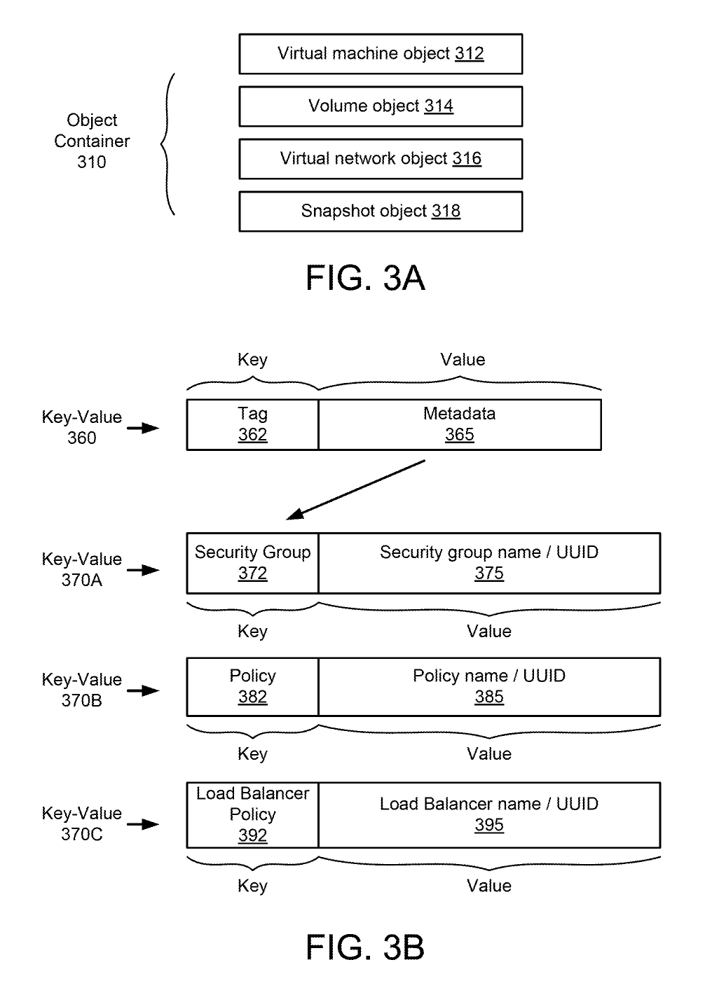

In some embodiments, the tag generator 230 stores each of the tags as two layers of key-value pairs. The two layers of key-value pairs may include a first layer of a key-value pair and a second layer of a key-value pair. The first layer of the key-value pair may include (i) a tag as a key and (ii) an associated metadata indicating a location of the second layer of the key-value pair stored as a value. The second layer of the key-value pair may include (i) a characteristic of the corresponding data object as a key and (ii) a description of the distributed database storing the data object together with the global identification as a value. For example, the tag generator 230 generates the first layer of the key-value pair associated with a data object including (i) a combination of a local identification of the data object identified by the database storing the data object and a UUID of the data object assigned by the tag generator 230, and a description of the database storing the data object as a key, and (ii) metadata indicating a location (or a key) of the second layer of the key-value pair associated with the data object stored as a value. Furthermore, the tag generator 230 generates the second layer of the key-value pair associated with the data object including (i) a characteristic of the data object as a key, and (ii) a combination of a description of a location of the data object stored and the UUID of the data object as a value. Advantageously, tags generated by the tag generator 230 allow the object tracker 250 to track different data objects stored by different databases. Additional examples of the tags are described below with respect to FIGS. 3A and 3B.

The object tracker 250 is a component that tracks virtual machines or data objects of virtual machines. The object tracker 250 may search for data objects according to instructions or commands received through the communication interface 210 or from the virtual machine controller 270. In one approach, the object tracker 250 tracks statuses of particular virtual machines or changes configurations of the particular virtual machines through associated tags. For example, the object tracker 250 identifies data objects of virtual machines with particular characteristics by searching for key-value pairs having particular characteristics in the key-value pairs (e.g., keys of key-value pairs in the second layer) and further obtaining UUID of the data object from the searched key-value pairs. Based on the UUID of the data object and the description of the location of the data object, the object tracker 250 may track the identified data objects or retrieve the identified data objects.

The virtual machine controller 270 is a component that updates configurations of virtual machines. In one approach, the virtual machine controller 270 may receive instructions or commands to update configurations of virtual machines through the communication interface 210. The virtual machine controller 270 may also instruct the object tracker 250 to track statuses of the virtual machines or change statuses of the virtual machines. The virtual machine controller 270 may configure configurations of the tracked or retrieved virtual machines, and update data objects of the virtual machines.

In one aspect, the object tracker 250 and the virtual machine controller 270 operate together to locate data objects having a certain characteristic and change configurations of virtual machines in a prompt and computationally efficient manner. For example, the object tracker 250 can identify virtual machines managed by a particular entity, virtual machine images stored by a particular database, or virtual machines operating based on a particular security setting by searching for tags of data objects with a target characteristic, rather than searching through virtual machines in different databases. In addition, the virtual machine controller 270 may change certain configurations (e.g., version, security setting, policy, network access, storage amount, etc.) of the identified virtual machines together.

Referring to FIGS. 3A and 3B, illustrated are example formats of data structure associated with virtual machines, in accordance with some embodiments of the present disclosure. FIG. 3A shows an object container 310 comprising data objects that include a virtual machine object 312, a volume object 314, a virtual network object 316, and a snapshot object 318 associated with a virtual machine. Each of the data objects may be associated with corresponding key-value pairs as shown in FIG. 3B. In FIG. 3B, two levels of key-value pairs are illustrated. For example, the key-value pair 360 corresponds to a first level of the key-value pairs associated with a data object, and the key-value pairs 370 correspond to a second level of the key-value pairs associated the data object. In one implementation, the key-value pair 360 includes (i) a key indicating a tag 362 to identify an associated data object, and (ii) a value indicating associated metadata 365. The metadata 365 may indicate a location (or a key) of the second layer of the key-value pair. The key-value pair 370A includes (i) a key indicating a security group 372 of the data object, and (ii) a value indicating a combination of a security group name and a UUID of the data object. The key-value pair 370B includes (i) a policy 382 of the data object, and (ii) a value indicating a combination 375 of a policy name and a UUID of the data object. The key-value pair 370C includes (i) a load balancer policy 392 of the data object, and (ii) a value indicating a combination 395 of a load balancer name and a UUID of the data object. Through various key-value pairs of data object, virtual machines or data objects of the virtual machines can be identified in an efficient manner.

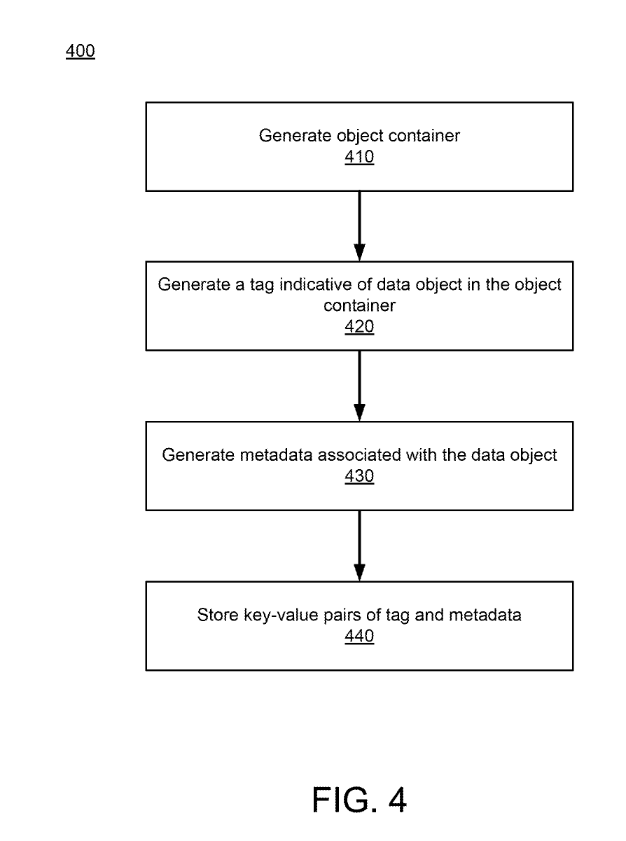

Referring to FIG. 4, illustrated is an example flowchart showing a process 400 for generating data associated with virtual machine for tracking, in accordance with some embodiments of the present disclosure. The process 400 may be performed by the virtual machine tracker 200. In other embodiments, the process 400 may be performed by other entities. In other embodiments, the process 400 includes more, fewer, or different operations than shown in FIG. 4.

The virtual machine tracker 200 generates 410 an object container associated with a virtual machine. The virtual machine tracker 200 may receive a user instruction to store data associated with a virtual machine, and generate an object container associated with the virtual machine. The object container includes one or more data objects associated with the virtual machine. Examples of data objects include a virtual machine object, a volume object, a virtual network object, a snapshot object, etc.

The virtual machine tracker 200 generates 420 a tag indicative of the data object. In one approach, each data object is identified by a corresponding tag including a global identifier. The global identification is unique across a consolidated database including different databases operated by different entities. The virtual machine tracker 200 generates 430 metadata associated with the object container. In one aspect, the metadata indicates characteristics of the data object.

The virtual machine tracker 200 generates and stores 440 key-value pairs of tag and associated metadata. For example, the virtual machine tracker 200 stores the key including the tag and the value including the metadata at a distributed database.

In some embodiments, the virtual machine tracker 200 stores two layers of key-value pairs. In one approach, the virtual machine tracker 200 stores the first layer of the key-value pair associated with a data object including (i) a combination of a local identification of the data object identified by a database storing the data object and a global identification (e.g., UUID) of the data object and a description of the database storing the data object as a key, and (ii) metadata indicating a location (or a key) of the second layer of the key-value pair associated with the data object stored as a value. Furthermore, the virtual machine tracker 200 stores the second layer of the key-value pair associated with the data object including (i) a characteristic of the data object as a key, and (ii) a combination of a description of a location of the data object stored and the UUID of the data object as a value. Accordingly, virtual machines or data objects of virtual machines can be identified in a computationally efficient manner. Based on the tags, different data objects stored by different databases can be readily identified from the distributed database, and virtual machines of the identified data objects can be configured together.

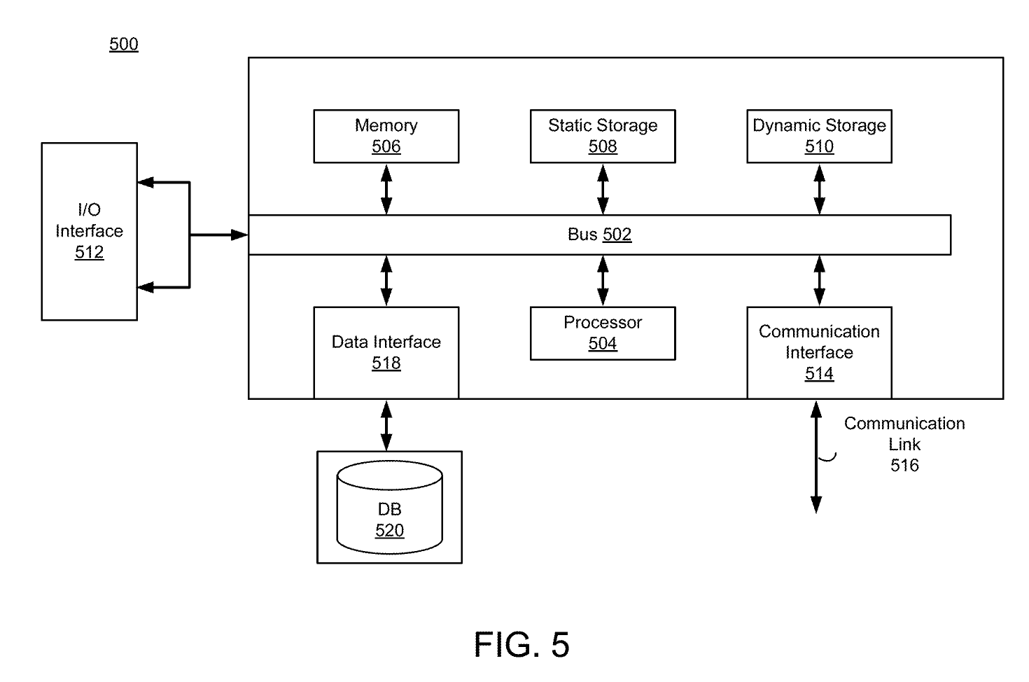

Referring to FIG. 5, illustrated is a block diagram of an illustrative computing system 500 suitable for implementing particular embodiments. In particular embodiments, one or more computer systems 500 perform one or more operations of one or more methods described or illustrated herein. In particular embodiments, one or more computer systems 500 provide functionality described or illustrated herein. In particular embodiments, software running on one or more computer systems 500 performs one or more operations of one or more methods described or illustrated herein or provides functionality described or illustrated herein. Particular embodiments include one or more portions of one or more computer systems 500. Herein, reference to a computer system may encompass a computing device, and vice versa. Moreover, reference to a computer system may encompass one or more computer systems.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, a laptop or notebook computer system, a tablet computer system, or a combination of two or more of these. Computer system 500 may include one or more computer systems 500; be unitary or distributed; span multiple locations; span multiple machines; span multiple data centers; or reside in a cloud, which may include one or more cloud components in one or more networks. One or more computer systems 500 may perform without substantial spatial or temporal limitation one or more operations of one or more methods described or illustrated herein. As an example and not by way of limitation, one or more computer systems 500 may perform in real time or in batch mode one or more operations of one or more methods described or illustrated herein. One or more computer systems 500 may perform at different times or at different locations one or more operations of one or more methods described or illustrated herein.

In some embodiments, the computer system 500 includes a bus 502 (e.g., an address bus and a data bus) or other communication mechanism for communicating information, which interconnects subsystems and devices, such as processor 504, memory 506 (e.g., RAM), static storage 508 (e.g., ROM), dynamic storage 510 (e.g., magnetic or optical), communication interface 514 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 512 (e.g., keyboard, keypad, mouse, microphone). In particular embodiments, computer system 500 may include one or more of any such components.

In particular embodiments, processor 504 includes hardware for executing instructions, such as those making up a computer program. As an example and not by way of limitation, to execute instructions, processor 504 may retrieve (or fetch) the instructions from an internal register, an internal cache, memory 506, static storage 508, or dynamic storage 510; decode and execute them; and then write one or more results to an internal register, an internal cache, memory 506, static storage 508, or dynamic storage 510. In particular embodiments, processor 504 may include one or more internal caches for data, instructions, or addresses. This disclosure contemplates processor 504 including any suitable number of any suitable internal caches. As an example and not by way of limitation, processor 504 may include one or more instruction caches, one or more data caches, and one or more translation lookaside buffers (TLBs). Instructions in the instruction caches may be copies of instructions in memory 506, static storage 508, or dynamic storage 510, and the instruction caches may speed up retrieval of those instructions by processor 504. Data in the data caches may be copies of data in memory 506, static storage 508, or dynamic storage 510 for instructions executing at processor 504 to operate on; the results of previous instructions executed at processor 504 for access by subsequent instructions executing at processor 504 or for writing to memory 506, static storage 508, or dynamic storage 510; or other suitable data. The data caches may speed up read or write operations by processor 504. The TLBs may speed up virtual-address translation for processor 504. In particular embodiments, processor 504 may include one or more internal registers for data, instructions, or addresses. This disclosure contemplates processor 504 including any suitable number of any suitable internal registers. Processor 504 may include one or more arithmetic logic units (ALUs); be a multi-core processor; or include one or more processors 504. Although this disclosure describes and illustrates a particular processor, this disclosure contemplates any suitable processor.

In particular embodiments, I/O interface 512 includes hardware, software, or both, providing one or more interfaces for communication between computer system 500 and one or more I/O devices. Computer system 500 may include one or more of these I/O devices. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 512 for them. I/O interface 512 may include one or more device or software drivers enabling processor 504 to drive one or more of these I/O devices. I/O interface 512 may include one or more I/O interfaces 512. Although this disclosure describes and illustrates a particular I/O interface, this disclosure contemplates any suitable I/O interface.

In particular embodiments, communication interface 514 includes hardware, software, or both providing one or more interfaces for communication (such as, for example, packet-based communication) between computer system 500 and one or more other computer systems 500 or one or more networks. As an example and not by way of limitation, communication interface 514 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 514 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 514 for any of these networks. Communication interface 514 may include one or more communication interfaces 514. Although this disclosure describes and illustrates a particular communication interface, this disclosure contemplates any suitable communication interface.

One or more memory buses (which may each include an address bus and a data bus) may couple processor 504 to memory 506. Bus 502 may include one or more memory buses, as described below. In particular embodiments, one or more memory management units (MMUs) reside between processor 504 and memory 506 and facilitate accesses to memory 506 requested by processor 504. In particular embodiments, memory 506 includes random access memory (RAM). This RAM may be volatile memory, dynamic RAM (DRAM) or static RAM (SRAM).

Moreover, this RAM may be single-ported or multi-ported RAM. This disclosure contemplates any suitable RAM. Memory 506 may include one or more memories 506. Although this disclosure describes and illustrates particular memory, this disclosure contemplates any suitable memory.

The ROM may be mask-programmed ROM, programmable ROM (PROM), erasable PROM (EPROM), electrically erasable PROM (EEPROM), electrically alterable ROM (EAROM), or flash memory or a combination of two or more of these. In particular embodiments, dynamic storage 510 may include a hard disk drive (HDD), a floppy disk drive, flash memory, an optical disc, a magneto-optical disc, magnetic tape, or a Universal Serial Bus (USB) drive or a combination of two or more of these. Dynamic storage 510 may include removable or non-removable (or fixed) media. Dynamic storage 510 may be internal or external to computer system 500. This disclosure contemplates mass dynamic storage 510 taking any suitable physical form. Dynamic storage 510 may include one or more storage control units facilitating communication between processor 504 and dynamic storage 510.

In particular embodiments, bus 502 includes hardware, software, or both coupling components of computer system 500 to each other. As an example and not by way of limitation, bus 502 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 502 may include one or more buses. Although this disclosure describes and illustrates a particular bus, this disclosure contemplates any suitable bus or interconnect.

In some embodiments, computer system 500 performs specific operations by processor 504 executing one or more sequences of one or more instructions contained in memory 506. Such instructions may be read into memory 506 from another computer readable/usable medium, such as static storage 508 or dynamic storage 510. In alternative embodiments, hard-wired circuitry may be used in place of or in combination with software instructions to implement particular embodiments. Thus, particular embodiments are not limited to any specific combination of hardware circuitry and/or software. In particular embodiments, the term “logic” shall mean any combination of software or hardware that is used.

The term “computer readable medium” or “computer usable medium” as used herein refers to any medium that participates in providing instructions to processor 504 for execution. Such a medium may take many forms, including but not limited to, nonvolatile media and volatile media. Non-volatile media includes, for example, optical or magnetic disks, such as static storage 508 or dynamic storage 510. Volatile media includes dynamic memory, such as memory 506.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In particular embodiments, execution of the sequences of instructions may be performed by a single computer system 500; in alternative embodiments, two or more computer systems 500 coupled by communication link 516 (e.g., LAN, PTSN, or wireless network) may perform the sequence of instructions in coordination with one another.

Computer system 500 may transmit and receive messages, data, and instructions, including program, i.e., application code, through communication link 516 and communication interface 514. Received program code may be executed by processor 504 as it is received, and/or stored in static storage 508 or dynamic storage 510, or other non-volatile storage for later execution. A database 520 may be used to store data accessible by the system 500 by way of data interface 518.

Herein, a non-transitory computer readable medium (also referred to as “computer-readable non-transitory storage medium”) includes instructions, when executed, cause a processor to execute various functionalities described herein. In some embodiments, a computer-readable non-transitory storage medium or media may be embodied as one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDS), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these. A computer-readable non-transitory storage medium may be volatile, non-volatile, or a combination of volatile and non-volatile.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A non-transitory computer readable medium storing instructions when executed by a processor cause the processor to:
generate an object container of a virtual machine, the object container including a data object associated with the virtual machine;
generate, for the data object, a tag uniquely identifying the data object across a distributed database; and
store the tag in the distributed database for tracking the data object in the distributed database based on the tag.

2. The non-transitory computer readable medium of claim 1, wherein the data object comprises:
a virtual machine object,
a volume object,
a virtual network object, or
a snapshot object.

3. The non-transitory computer readable medium of claim 1, wherein the distributed database comprises:
a first distributed database operated by a first entity; and
a second distributed database operated by a second entity different from the first entity.

4. The non-transitory computer readable medium of claim 1, wherein the tag is stored as a key and an associated metadata of the tag is stored as a value.

5. The non-transitory computer readable medium of claim 1, wherein the tag is stored as two layers of key-value pairs, the two layers of key-value pairs comprising a first layer key-value pair and a second layer key-value pair, wherein:
the first layer key-value pair comprises the tag as a first key and an associated metadata indicating a location of the second layer key-value pair as a first value; and
the second layer key-value pair comprises a characteristic of the data object as a second key and a description of the distributed database storing the data object together with identification of the data object as a second value.

6. (canceled)

7. The non-transitory computer readable medium of claim 1, wherein the processor is further configured to:
identify a plurality of data objects of virtual machines sharing a common characteristic based on tags of the plurality of data objects; and
change configurations of the virtual machines.

8. The non-transitory computer readable medium of claim 7, wherein the processor is further configured to
change security configurations of the virtual machines sharing the common characteristic.

9. A method comprising:
generating an object container of a virtual machine, the object container including a data object associated with the virtual machine;
generating, for the data object, a tag uniquely identifying the data object, each tag including a global identification of the corresponding data object across a distributed database; and
storing the tag in the distributed database for tracking the data object in the distributed database based on the tag.

10. The method of claim 9, wherein the data object comprises:
a virtual machine object,
a volume object,
a virtual network object, or
a snapshot object.

11. The method of claim 9, wherein the distributed database comprises:
a first distributed database operated by a first entity; and
a second distributed database operated by a second entity different from the first entity.

12. The method of claim 9, wherein the tag is stored as a key and an associated metadata associated with the tag is stored as a value.

13. The method of claim 9, wherein the tag is stored as two layers of key-value pairs comprising a first layer key-value pair and a second layer key-value pair, wherein:
the first layer key-value pair comprises the tag as a first key and an associated metadata indicating a location of the second layer key-value pair as a first value; and
the second layer key-value pair comprises a characteristic of the data object as a second key and a description of the distributed database storing the data object together with identification of the data object as a second value.

14. (canceled)

15. The method of claim 9, further comprising:
identifying a plurality of data objects of virtual machines sharing a common characteristic based on tags of the plurality of data objects; and
changing configurations of the virtual machines.

16. The method of claim 15, wherein changing the configurations of the virtual machines includes changing security configurations of the virtual machines sharing the common characteristic.

17. A system comprising:
a processor; and
a non-transitory computer readable medium storing instructions when executed by the processor cause the processor to:
generate an object container of a virtual machine, the object container comprising a data object associated with the virtual machine;
generate, for the data object, a tag uniquely identifying the data object across a distributed database; and
store the tag in the distributed database for tracking the data object in the distributed database based on the tag.

18. The system of claim 17, wherein the data object comprises:
a virtual machine object,
a volume object,
a virtual network object, or
a snapshot object.

19. (canceled)

20. The system of claim 17, wherein the processor is further programmed to:
identify a plurality of data objects of virtual machines sharing a common characteristic based on tags of the plurality of data objects, and
change configurations of the virtual machines.
